(19) United States
(12) Patent Application Publication
(10) Pub. No.: US 2007/0050465 A1
(43) Pub. Date: Mar. 1, 2007

(54) PACKET CAPTURE AGENT FOR USE IN FIELD ASSETS EMPLOYING SHARED BUS ARCHITECTURE

(76) Inventors: James M. Canter, Austin, TX (US); Bryan W. Godwin, Round Rock, TX (US); Timothy McDaniel, Florence, TX (US)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/464,127

(22) Filed: Aug. 11, 2006

Related U.S. Application Data
(63) Continuation-in-part of application No. 10/722,954, filed on Nov. 26, 2003.
(63) Continuation-in-part of application No. 09/971,170, filed on Oct. 4, 2001.
Application No. 09/971,170 is a continuation-in-part of application No. 09/267,254, filed on Mar. 12, 1999, now Pat. No. 6,457,038.
(60) Provisional application No. 60/429,756, filed on Nov. 27, 2002.
(60) Provisional application No. 60/480,626, filed on Jun. 23, 2003.
(60) Provisional application No. 60/078,645, filed on Mar. 19, 1998.
(60) Provisional application No. 60/099,434, filed on Sep. 8, 1998.

(51) Int. Cl. G06F 15/16

(52) U.S. Cl. 709/209

(57) ABSTRACT

A field asset suitable for use in a machine to machine environment includes a machine controller configured to function as a master of a shared bus (e.g. an MDB bus) and one or more slave peripheral devices connected to the bus. The field asset includes a snoop agent to capture packets transmitted on the shared bus. The snoop agent may be implemented as a microcontroller coupled to the MDB bus via a UART and isolation circuitry and controlled by appropriate packet capture firmware. The microcontroller may capture and buffer captured data and send the buffered data to a snoop application module. The application module may be implemented as part of an extended function adapter including an embedded processor in communication with the microcontroller.

### RELATED APPLICATIONS

This application is a Continuation-In-Part of application Ser. No. 10/722,954, filed Nov. 26, 2003 and hereby incorporated by reference, which claims the benefit of Provisional Application No. 60/429,756, filed Nov. 27, 2002 and Provisional Application No. 60/480,626, filed Jun. 23, 2003, and which is a Continuation-In-Part of application Ser. No. 09/971,170, filed Oct. 4, 2001, which is a Continuation-in-Part of application Ser. No. 09/267,254, filed Mar. 12, 1999 (now U.S. Pat. No. 6,457,038), which claims the benefit of Provisional Application No. 60/078,645, filed Mar. 19, 1998 and Provisional Application No. 60/099,434, filed Sep. 8, 1998.

### TECHNICAL FIELD

The present invention relates in general to the field of machine to machine (M2M) technology and, more particularly, the architecture of remote or field assets in an M2M environment.

### BACKGROUND OF THE INVENTION

Machine to machine (M2M) technology refers generally to the ability of machines, devices, and assets, particularly those that are distributed or remote, to exchange information with people and/or with a corporate management system. Although a precise definition of M2M is difficult to formulate, M2M generally encompasses the use of telemetry via networks including, but not limited to, public wireless networks.

Historically, telemetry systems were limited to applications for conglomerates and other well financed organizations. Large oil and gas companies and electric utilities, through the use of extensive customer built dedicated data networks, were among the first private organizations to use telemetry widely. More recently, however, the cost of access to public wireless data networks has been dropping while the capabilities of these networks has been increasing thus making M2M concepts feasible for a much larger audience.

The M2M systems described herein generally include remotely located machines or devices referred to as field assets. Although field assets may encompass any variety of specific types of machines (oil rigs, cellular phone system base stations, ATM machines, and weather monitors), the specific embodiments described herein are in the field of vending machines. Vending machines are unmanned, electromechanical devices that dispense products including consumable products such as soft drinks and snack foods in exchange for cash or other form of payment. Vending machines are generally deployed as remotely located field assets by a company that manages a plurality of such devices.

In the field of vending machines, the traditional extent of automation consisted primarily of the ability retrieve “snapshots” of inventory data from a vending machine using a wired, hand held device and a specialized, industry standard, data exchange (DEX) protocol and interconnect. DEX is a communication protocol (DEX) for the electronic retrieval of machine-level transactions via data polling. While DEX has served its purpose well for a considerable period of time, DEX is not capable of analyzing vending machine sales beyond the most superficial level. Nor is DEX capable of providing information that could be used to manage a vending machine from a maintenance perspective. Moreover, a DEX polling event effectively takes a vending machine off line, even if for only a short duration. This limitation prevents it from serving as a real time transaction monitoring protocol.

More recently, the Multi Drop Bus/Internal Communication Protocol (MDB/ICP or, more simply MDB) vending machine technology has evolved. MDB defines a bus interface and standard for electronically controlled vending machines. Unlike DEX, MDB provides a control mechanism and standard for the various peripheral devices typically encountered in a vending machine. Moreover, MDB supports a level of time stamping that enables insight into information that is potentially valuable to a vending machine company. Despite the opportunities for expanded functionality and data insight offered by MDB, conventional MDB compliant vending machines tend to utilize MDB merely as an interconnect between a VMC and one or more peripherals and, possibly, a source of DC power.

Nevertheless, some efforts have been devoted to adding functionality to conventional vending machines. For example, U.S. patent application Ser. No. 10/722,954, referred to above, describes a processor-based Audit Device having access to the MDB bus and to the VMC via a DEX port. Using this Audit Device, a vending machine can greatly improve the amount and quality of information concerning sales. If, for example, sales of a particular vending machine vary considerably from day to day and even within a day, conventional DEX polling, which might take place on a weekly basis, for example, will not be able to identify these variations and the inability to do so could result in lost sales opportunities.

Using such an Audit Device, a vending machine can retrieve and store a plurality of DEX downloads together with information from which time stamps can be derived for each DEX download. While the ability to place DEX data in a timing context represents an advance a vending machine management, it would be still further desirable to continue to extend the functionality of vending machines to encompass information that is outside the scope of DEX or to capture and enhance traditional DEX data without performing a DEX download.

### SUMMARY OF THE INVENTION

The objectives stated above are at least in part addressed by a field asset implementation described herein in which a field asset employs an packet capture agent sometimes referred to herein as a snoop agent or an MDB Offload Engine (MOE) to capture MDB packets. Capturing packets directly from the MDB serves a variety of purposes including, as examples, enabling feedback of field asset performance and customer behavior in real time, without requiring a DEX polling event, uncoupling field asset monitoring from the DEX standard, and facilitating the gathering of quantifiable, time-based consumer behavior data.

In accordance with teachings of the present disclosure, a field asset suitable for use in a machine to machine environment includes a machine controller configured to function as a master of a shared bus, one or more slave peripheral devices connected to the bus, wherein the peripheral devices receive packets from the machine controller and send packets back to the machine controller in response. In addition to the peripheral devices, an MDB offload engine is provided and configured to capture packets transmitted on the shared bus.

The machine controller may be the sole master of the shared bus and the slave peripheral devices transmit packets only in response to receiving packets from the machine controller. The machine controller may be a vending machine controller (VMC) and the shared bus may be Multi Drop Bus (MDB) compliant. The peripheral devices may include a coin mechanism, a bill acceptor, and a card reader. The card reader may be coupled to the MDB directly or implemented by interfacing a magnetic stripe reader to an I/O port of an adapter board. In this embodiment, the adapter board may be an extended function adapter (EFA), which may incorporate extended functions including the packet capture agent and, possibly, other extended functions as well, e.g., a DEX Audit agent.

The EFA may include an embedded controller, a UART coupled to the MDB, access to storage or memory, and various peripheral interfaces. The MOE may also include a microcontroller coupled to the embedded processor. The embedded controller firmware controls packet filtering and analysis and includes a MOE device driver. MOE firmware is responsible for reliably capturing MDB data, time-stamping the data, and reporting MDB protocol violations. MDB data may be buffered on the MOE. The MOE may then interrupt the embedded processor to signal the embedded controller that data is available.

### BRIEF DESCRIPTION OF THE DRAWINGS

A more complete and thorough understanding of the present embodiments and advantages thereof may be acquired by referring to the following description taken in conjunction with the accompanying drawings, in which like reference numbers indicate like features, and wherein:

FIG. 1 is a block diagram of selected elements of a machine to machine application including a plurality of remotely located field assets;

FIG. 2 is a block diagram of a vending machine according to the prior art;

FIG. 3 is a block diagram of selected elements of a field asset of FIG. 1 emphasizing the asset's multi drop bus architecture and selected peripheral devices;

FIG. 4 is a block diagram of selected elements of an implementation of the extended function adapter in the field asset of FIG. 3 emphasizing hardware and firmware elements of an MDB Offload Engine (MOE); and

FIG. 5 is a diagram of selected pin connections for one embodiment of a microcontroller suitable for use in the MOE of FIG. 4;

FIG. 6 is a block diagram illustrating selected firmware elements of an MOE implementation;

FIG. 7 is an exemplary format for an MDB snoop buffer data structure;

FIG. 8 is an exemplary format for an MDB snoop data packet;

FIG. 9 is an exemplary format for an MDB snoop error packet;

FIG. 10 is an exemplary format for an MDB MOE Firmware Version packet; and

FIG. 11 is an exemplary format for an MDB snoop end of buffer data structure.

### DETAILED DESCRIPTION OF THE INVENTION

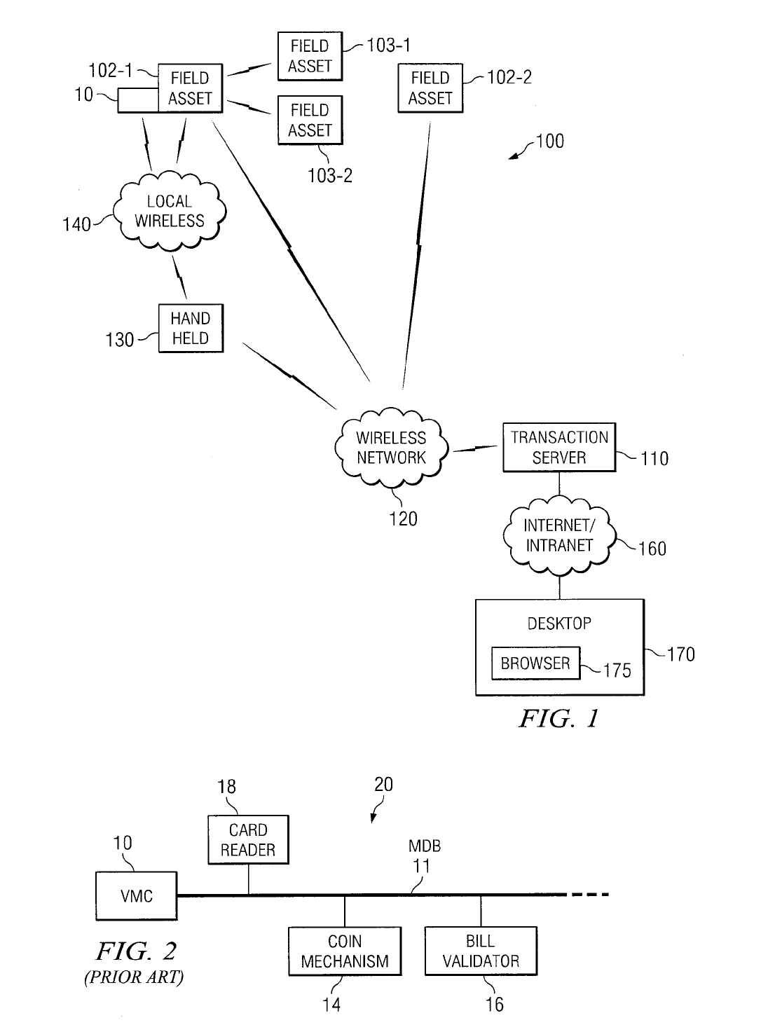

Preferred embodiments of the invention and its advantages are best understood by reference to FIG. 1 through FIG. 11, wherein like numerals indicate like and corresponding parts of the invention. Where different instances of a particular element are shown, they may be numbered with hyphenated reference numerals to indicate a common design or functionality. For example, elements 102-1 and 102-2 may be instances of a generic 102 element.

In one aspect, a machine to machine (M2M) network for remote field assets is described. M2M network 100 includes a collection of remotely located field assets 102, 103 in communication with a transaction processing server 110. Transaction processing server 110 communicates with a field assets 102 via a wide area wireless network or via local wireless networks using a hand held data processing device as an intermediary. Some field assets, including field assets 103, may lack wireless WAN connectivity and may, therefore, communicate with transaction processing server 110 through an intermediate field asset such as field asset 102-1.

Field assets 102 and 103 are exemplified by vending machines in which transactions likely include the sale of consumer goods stocked in the vending machine. In some embodiments, field asset 102 or 103 is an MDB compliant vending machine that includes a vending machine controller (VMC) as the master of an industry standard MDB bus to which one or more peripheral devices are connected. In addition to conventional peripheral devices such as bill validators and coin mechanisms, a field asset may include hardware, firmware, and/or software that implements a platform for providing value added functionality to the vending machine or other field asset. This collection of hardware, software, and/or firmware is referred to herein as an extended function adapter (EFA).

The EFA supports one or more beneficial capabilities that facilitate automated vending machine management. An area of EFA functionality of special interest is an MDB offload engine (MOE) to capture and buffer or otherwise store packets on the MDB. In some embodiments, the EFA integrates two or more distinct extended function features. The EFA may, for example, include a audit agent that includes the capacity to perform DEX polling and to store and time stamp the captured DEX data structures.

Referring now to the drawings, FIG. 1 is a block diagram of selected elements of one embodiment of an M2M network 100 including one or more field assets, examples of which are depicted as field assets 102-1 and 102-2 (generically or collectively referred to herein as field asset(s) 102) and field assets 103-1 and 103-2. Field assets 102 are depicted in FIG. 1 as being operable to communicate with a transaction server 110. Field assets 102 may be any set of machines or devices, typically having similar functionality, that are remotely distributed and capable of engaging in some form of transaction. Examples of field assets include oil rigs, cellular phone system base stations, ATM machines, and weather monitors.

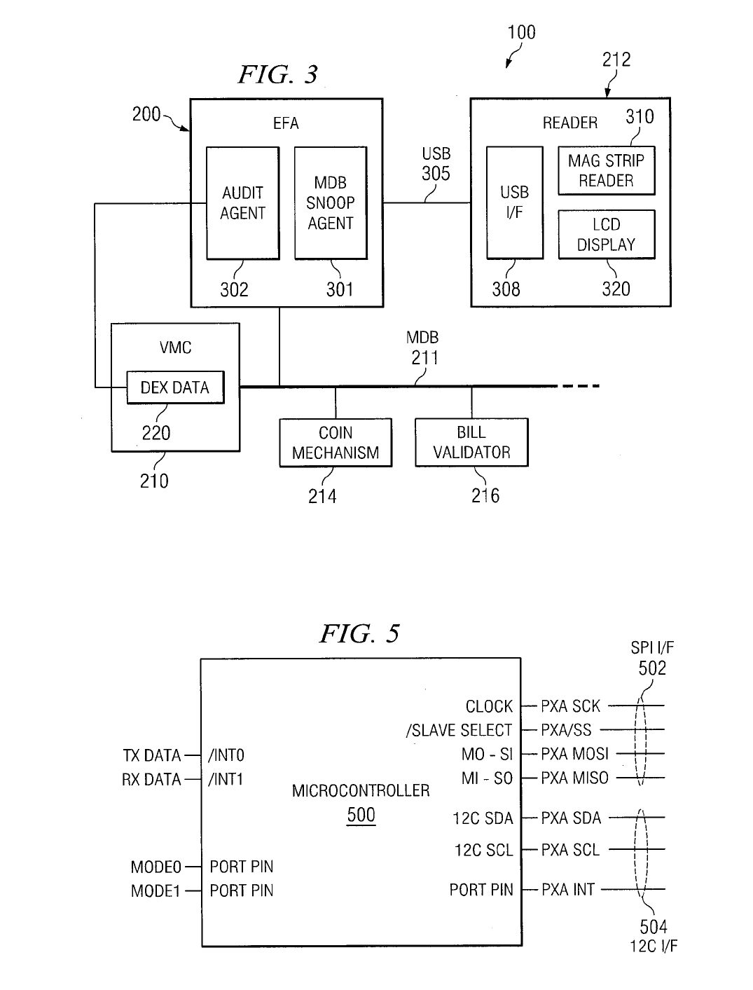

The packet capture features are described herein in the context of a vending machine class of field assets. Vending machines are ubiquitous machines historically used as an unmanned source of perishable and nonperishable consumer products including canned and bottled drink products, snack foods, and so forth. Details of one embodiment of a field asset are described below with respect to FIG. 3.

In the embodiment depicted in FIG. 1, field assets 102 and 103 communicate with transaction server 110 wirelessly via alternative communication paths. Field asset 102-2 is depicted as connecting “directly” to transaction server 110 via a wireless medium and wireless network 120. Wireless network 120 may employ wireless cellular technology including the well known use of multiple base stations positioned in specified locations to communicate wireless signals across a wide geographic area.

Field asset 102-1 is depicted as being capable of communicating wirelessly with a hand held device 130 via a local wireless network 140 or directly with transaction processing server 110 via wireless net 120. Field assets 103 communicate locally with field asset 102-1 and use field asset 102-1 to act as a relay station for information from devices 103-1 and 103-2.

The hand held device 130 is shown as connecting to transaction server 110 using wireless network 120, sometimes referred to herein as global wireless network to distinguish local wireless network 140. Local wireless network 140 may be implemented using any of a variety of short range wireless technologies including as perhaps the most prominent examples, Bluetooth and WiFi (e.g., IEEE 802.11b, IEEE 802.11g, and their derivatives).

In the case of local wireless communication, an operator conveys hand held device 130 to a location that is in close proximity to a field asset 102. The field asset 102 and hand held 130 establish a local wireless signal enabling communication between the two. After establishing a local wireless communication channel, field asset 102 and hand held 130 exchange data or information. Field asset 102 may, as an example, transmit sales transaction information to hand held 130.

Hand held 130 then conveys the information it has received from field asset 102 to transaction server 110 via wireless network 120. Alternatively, transfer of information from field asset 102-1 to transaction server 110 could be achieved by transferring the data from field asset 102-1 to hand held 130 using local wireless network 140, transporting hand held 130 to a location in proximity to transaction server 110, and transmitting the information in hand held 130 to interaction server 110 via another local wireless (not depicted) transfer. In still another alternative, information may be passed from field asset 102-1 to hand held 130 and/or from hand held 130 to transaction server 110 using a cable or other wired connection, possibly to enhance the security of confidential information.

Transaction server 110 may be implemented as a set of one or more server class computers operable to process many transactions. Transaction server 110 may include, as an example, a database management application (e.g., Oracle, DB2, etc.)

A desktop data processing system 170 is depicted in FIG. 1 as being coupled to transaction server 110 via the Internet or intranet represented by reference numeral 160. Desktop 170 includes a processor, memory, and I/O peripherals according to any of various well known desktop designs. Desktop 170 includes an operating system (OS) and a conventional web browsing application represented by reference numeral 175.

As depicted in FIG. 1, M2M network 100 includes various components that facilitate high volume transaction processing in a remotely distributed architecture that includes wireless communication elements, which may be characterized by relatively unreliable or unstable communication paths to all or some of the remote assets. The elements of M2M network 100 include (1) remote communication facilities to communicate with remote assets over multiple forms of wireless networks, (2) hand held technology suitable for mobile access to the field assets and to a transaction server, (3) server software for processing volumes of transactions, and (4) browser based access to useful information provided by transaction server 110. Although not depicted explicitly in FIG. 1, value added facilities in field assets 102 and 103 include an expandable, PC industry standard communication interface to legacy equipment. The EFA serves this last function and is described in greater detail below. In the preferred embodiment, the EFA provides a platform for interfacing to archaic or otherwise unique protocols such as Data Exchange (DEX) and Multi-Drop Bus (MDB) commonly encountered in remote field asset applications and especially in the vending machine industry.

The type of information conveyed or otherwise exchanged between field assets 102 and interaction server 110 varies depending upon the manner in which and the purpose for which field asset 102 is implemented, but the information most likely includes information about transactions that occur or have occurred using field assets 102. The transaction information referred to can include, as examples, information about when a transaction occurs and other transaction details, for example, what product or combination of products were purchased, what consumer or customer purchased the product (if known), the dollar amount of the purchase, the amount of time required to complete the purchase, the manner of payment, and other information that may be useful to vending machine operators and/or the providers of goods sold through field assets 102.

Referring now to FIG. 2, selected elements of a conventional MDB-compliant vending machine 20 according to well known prior art is shown. Vending machine 20 includes a vending machine controller 10 and various peripherals devices all connected to a multi drop bus 11. The peripheral devices consist of a coin mechanism 14, a bill validator 16, and a card reader 18. As depicted in FIG. 2, MDB provides a standardized interface for connecting vending machine peripheral devices to a VMC. Although the provision of an interface to which various manufacturers of vending machine peripheral equipment can all comply is highly beneficial, the embodiment of vending machine 20 depicted in FIG. 2 does little in terms of altering the data collection and analysis paradigm of pre-existing DEX machines. Because peripheral devices 14, 16, and 18 are essentially “dumb” devices, all of the available data resides in VMC 10 in the form of traditional DEX data structures. The field assets described below, in contrast, include value added functional elements connected to the MDB to alter and improve the data collection capabilities of the described assets.

Referring now to FIG. 3, an embodiment of a field asset 102 is shown. While the elements of FIG. 3 are applicable to field assets 103 of FIG. 1, the remainder of the discussion will use reference numeral 102 exclusively for the sake of simplicity. In the depicted embodiment, field asset 102 is an MDB compliant machine or device that includes a VMC 210 connected to an MDB 211, to which a plurality of peripheral devices are connected.

As shown in FIG. 2, field asset 102 has at least three peripheral devices including a coin mechanism 214, a bill validator 216, and a card reader 212. These peripheral devices are well known devices in the field of vending machines generally and MDB compliant vending machines in particular. As implemented in FIG. 3, coin mechanism 214 and bill validator 216 connect directly to MDB 211 while card reader 212 is shown as connecting to MDB 211 using extended function adapter (EFA) 200 as an intermediary. In the depicted embodiment, card reader 212 connects to EFA 200 via a Universal Serial Bus (USB) connection 305. Card reader 212 is shown as including a magnetic strip reader 310, a Liquid Crystal Display (LCD) display 320, and a USB Interface 308, providing access to USB connection 308.

MDB 211 is compliant with the Multi-Drop Bus/Internal Communication Protocol (the MDB protocol) maintained by the National Automatic Marketing Association (NAMA). The MDB protocol is an Interface Standard that allows the various components of a vending machine to communicate to the VMC. The MDB protocol determines the way in which the VMC learns what coins were accepted by the Coin Mechanism, what bills were accepted by the Bill Validator, and how much credit is available through the Card Reader. It is a way for the VMC to “tell” the Coin Mechanism how much change to pay out or to “tell” the card reader how much credit to return to the card.

Unlike many shared bus protocols, the MDB protocol defines the VMC as the one and only master of the MDB and all other peripherals as slaves. The VMC can address packets to any of the peripheral devices, but peripheral devices cannot communicate with each other and only transmit packets to the VMC in response to receiving a packet from the VMC. Also, as suggested previously, MDB is a polling-based protocol. A significant percentage of MDB traffic consists of polling packets issued by the VMC and acknowledge packets from the peripheral devices. In most shared bus architectures, e.g., Ethernet and PCI, devices can act as masters or slaves and polling is not an inherent feature of the architecture.

EFA 200, as its name suggests, includes application extensions that enhance the features of field asset 200. In conjunction with VMC 210, EFA 200 may include an Audit Agent 302 suitable for retrieving DEX data 220 from VMC 210. In addition, the depicted embodiment of EFA 200 beneficially include an MDB snoop agent 301 enabled to capture and buffer or otherwise store MDB packets.

The ability to capture MDB packets enables a variety of different applications. MDB packet traffic may be captured and analyzed to achieve time-based and DEX independent auditing capabilities. As another example, MDB packet traffic can also be used to monitor system health. Moreover, by combining MDB packet capture capabilities in conjunction with EFA 200 as described below, field asset 102 achieves an unprecedented level of data collection and analysis functionality. When further implemented in conjunction with networking and communication capabilities, field asset 102 represents a highly intelligent component of an automated network of field assets.

The elements of EFA 200 depicted in FIG. 3 include an MDB snoop agent 301 and an audit agent 302. Audit agent 302 interacts with VMC 210, typically through a conventional RS-232 link, to retrieve or poll DEX data 220 from VMC 210. EFA 200 may be programmed to poll DEX data 220 multiple times each day and to store the data for each such polling event and the time associated with each event. In this manner, Audit agent 302 can create a dynamic view of DEX data. Audit agent 302 may also audit other aspects of field asset 102 including, for example, information captured by MDB snoop agent 301.

MDB snoop agent 301 includes hardware, software, and/or firmware support to capture MDB packets as they appear on MDB 211 and provide them to an audit engine or application for further study. As described in greater detail below, MDB snoop agent 301 may be implemented, at least in part, as a daughter board that attaches to EFA 200 and includes a microcontroller and other circuitry required to implement packet capture in an MDB environment.

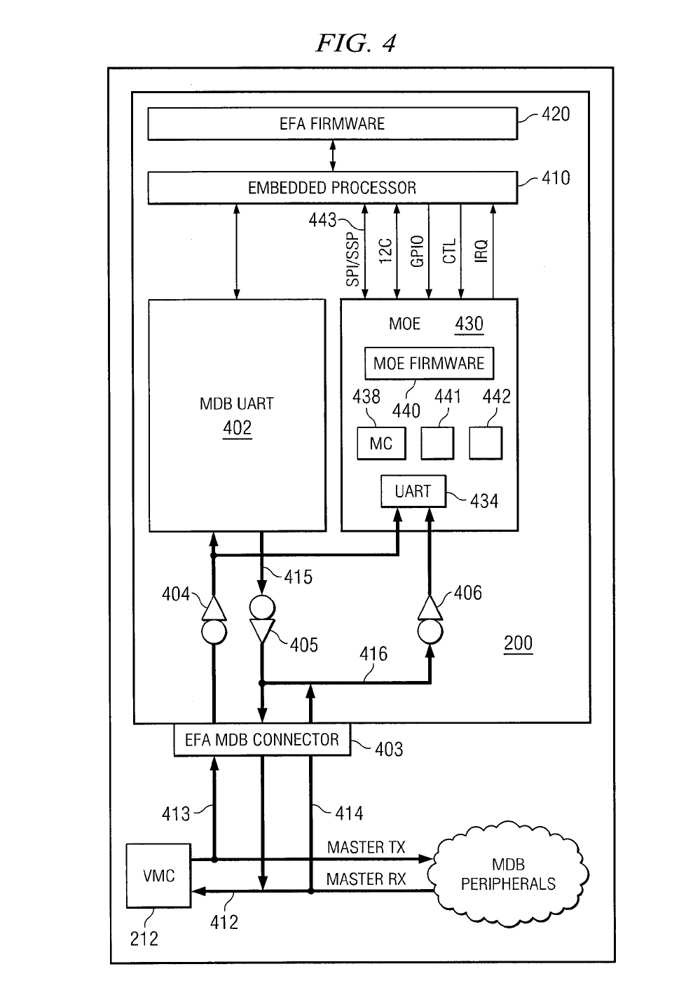

Turning now to FIG. 4, details of implementing one embodiment of MDB snoop agent 301 of FIG. 3 in EFA 200 are depicted. As depicted in FIG. 4, snoop agent 301 includes a hardware element referred to as the MDB Offload Engine (MOE) 430. In the depicted embodiment, MOE 430 is integrated into EFA 200 or attached to EFA 200 as a daughter card.

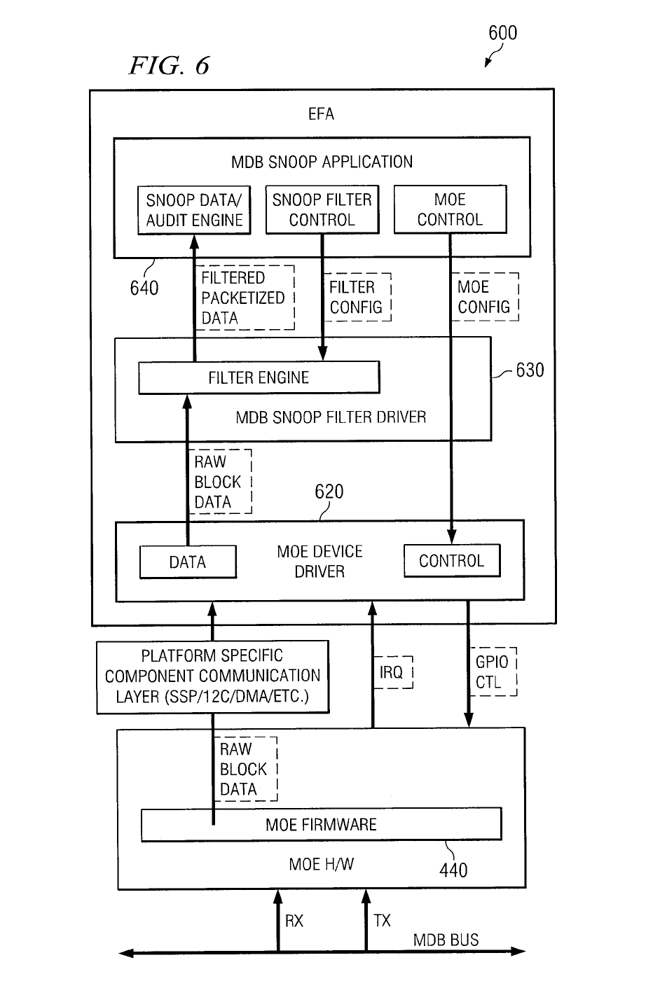

EFA 200 as shown in FIG. 4 includes, in addition to MOE 430, isolation circuits 404, 405, and 406, a serial/parallel converter referred to as MDB UART 402, an embedded processor 410, and EFA firmware 420. EFA firmware 420 represents a nonvolatile storage element containing instructions that are executable by embedded processor 410. The nonvolatile storage element is preferably a programmable storage element such as a flash memory element although other forms of storage may be used. EFA firmware 420 contains instructions that implement at least some of the functionality of EFA 200. This functionality may include, depending upon the implementation, control functionality for card reader 212, audit agent 302 and wireless communication functionality including local wireless functions such as Bluetooth and/or IEEE 802.11-type functionality. In the case of MOE 301 as depicted in FIG. 4, EFA firmware 420 includes code, described in further detail below with respect to FIG. 6, that communicates with and provides control functions for MOE 403.

Embedded processor 410 preferably includes a microprocessor core for executing instructions at high speeds (e.g., 300 MHz or greater), a memory controller, one or more UARTs, and a set of peripheral interfaces. A commercially distributed family of embedded processors suitable for use as embedded processor 410 is the PXA27x family of embedded processors from Intel® Corporation. For a detailed specification of this type of embedded processor, the reader is referred to the Intel® PXA27x Processor Family Developer's Manual, from Intel® Corporation, which is incorporated in its entirety by reference herein.

The implementation of MOE 430 depicted in FIG. 4 includes a microcontroller 438 having access to internal or external storage such as flash memory 440 and/or random access memory (RAM) 442. MOE firmware 440 provides a control program for microcontroller 438. A UART 434 of MOE 430 receives Master RX and Master TX MDB packets to and from VMC 210. FIG. 4 depicts an SPI/SSP interconnect between MOE 430 and embedded processor 410, which may be used to transfer captured data from an SPI (Serial Peripheral Interface) protocol interface of microcontroller 438 to an SSP (Synchronous Serial Protocol) of embedded processor 410.

Isolation circuits 404, 405, and 406 provide signal/power isolation between EFA 200 and MDB 211. Isolation circuits 404, 405, and 406 help ensure that MOE 430 does not initiate or disturb any packets on MDB 211. In the preferred embodiment, isolation circuits 404, 405, and 406 are implemented as optoisolation devices.

Master TX line 413 connects to an RX input of MDB UART 402 through isolation circuit 404 as shown while a TX output of MDB UART 402 connects to Master RX signal 412 via circuit 415 and isolation circuit 405. In the depicted embodiment, MOE 430 receives Master RX MDB packets from two sources, namely, MDB UART 402 and Master RX line 412. MDB UART 402 is the source of Master RX MDB packets for packets generated by card reader 212, which is interfaced to MDB 211 through EFA 200, while Master RX line 412 is the source of all other RX MDB packets. Accordingly, MOE UART 434 receives card reader Master RX MDB packets via circuit 416 from circuit 415. MOE UART 434 receives card reader packets from all other peripherals via circuits 416 and 414 through isolation circuit 406. By connecting to the Master RX and TX lines of MDB 211, MDB packet traffic is monitored bi-directionally so that all VMC request packets can be paired with the corresponding response packets from the appropriate peripheral device.

In one embodiment, microcontroller 438 of MOE 430 is implemented with a Atmega8 microcontroller, or equivalent, from Atmel Corporation. In this embodiment, microcontroller 438 contains 8K bytes of reprogrammable flash program memory, 512 bytes of EEPROM data memory, 1K bytes SRAM, an SPI controller and three timers.

FIG. 5 illustrates an exemplary implementation and pin connection for a microcontroller 500 suitable for use as microcontroller 438. As depicted in FIG. 5, The TX Data and RX Data inputs are connected to port pin interrupt inputs of microcontroller 500. MOE 430 may implement a receive data function using port pin interrupts of microcontroller 438 to detect the start of a character received on the TX Data and RX Data inputs. Received characters are buffered in microcontroller SRAM (not explicitly depicted) as 8-bit values (the mode bit of the MDB protocol is removed). Additional values are placed in the SRAM to form an MOE data packet. MOE data packets are sent via the SPI interface to embedded processor 410 of EFA 200.

A functional operating mode of controller 500 is set via two inputs (MODEO, MODE1)from embedded processor 410. The controller modes include RUN NORMAL, RUN TEST, TIME SYNC, and STOP. Microcontroller 500 monitors these port input pins to determine operating mode. Microcontroller 500 also includes an I2C interface 504 via which configuration of microcontroller 500 may be manipulated.

MOE 301 includes firmware 440 (FIG. 6) that may encompass five or more functional components including, Initialization, Mode detection, Character reception, SPI data transfer, and FLASH reprogramming.

Initialization sets the internal operating mode of microcontroller 500, configures the SPI interface 502, initializes internal SRAM, and sets the port pin functions. Mode detection is accomplished using a port change interrupt function of microcontroller 500. A change on MODEO/MODE1 port pins causes an interrupt. The interrupt sets the internal operational mode as follows: TIMER SYNC mode causes the time stamp value to be cleared, RUN NORMAL mode transfers MDB packets to embedded processor 410, RUN TEST mode transfers various test packets, and STOP mode suspends packet transfer.

Character reception is accomplished using the controller INT0/INT1 interrupts and internal timer interrupts. The INT0/INT1 interrupts detect the start of a character received on the TX Data and RX Data inputs.

The INT0/INT1 interrupts may also generate the character timestamp. Timer interrupts of microcontroller 500 may be used to time to the middle of each character data bit. Character data bits are preferably read from the INT0/INT1 port pins. Timer interrupt puts character data in the SRAM transmit buffer. It generates the packet byte count and increments the sequence number and puts this information in an SRAM transmit buffer.

SPI data transfer may occur as a background function of microcontroller 500. The microcontroller reads data from the SRAM transmit buffer and writes it to SPI control registers. Microcontroller 500 acts as an SPI master. Microcontroller 500 is enabled to interrupt embedded processor 410 if needed. SPI FIFO's of embedded processor 410 transfer data via DMA to internal memory of processor 410.

FLASH reprogramming allows the firmware 610 of microcontroller 500 to be updated in the field. Reprogramming is implemented via an on-chip Boot Loader program. FLASH memory of microcontroller 500 is divided into two sections—Application and Boot Loader. Firmware 610 of microcontroller 500 is contained in the Application section.

Thus, MOE 301 is enabled to capture all MDB packets both to and from VMC 210 and transmit them to embedded processor EFA 200 for further handling. EFA 200 may implement analysis applications, beyond the scope of this disclosure, to determine the health and status of field asset peripheral devices and MDB 211.

Turning to FIG. 6, selected software elements suitable for implementing an embodiment of MOE 301 are depicted. Some embodiments of the invention are implemented as computer program products including a set of instructions, executable by a processor such as embedded processor 410 or microcontroller 438, and stored on a computer readable medium such as a flash memory device, RAM, magnetic storage including hard disk storage, optical storage including CDs and DVDs and the like that enable field asset 102, preferably in conjunction with EFA 200 and MOE 430, to capture and buffer MDB packets for subsequent analysis by a module such as the Snoop Application 640 depicted in FIG. 6. The depicted embodiment of MOE software components 600 includes MOE firmware 610, MOE device driver 620, MDB Snoop Filter Driver 630, and MDB Snoop Application 640. MOE firmware 610 is resident on the MOE daughter card (when used) while device driver 620, Snoop Filter Driver 630, and Snoop Application 640 reside in flash memory or other storage of EFA 200 and embedded processor 410.

Snoop Application 640 is enabled to process post-filtered data, which includes a series of post-filtered packets captured from MDB 211. Snoop Application is preferably enabled to output data and inter-process messages related to problem diagnosis, system auditing, and system health. Snoop Application 640 will preferably execute as a low priority user-mode thread in the operating system of EFA 200. An exemplary operating system for EFA 200 is the WinCE 4.2 (or subsequent) operating system from Microsoft Corporation. Snoop application 640 may also function as a front end for an EFA-based MDB trace analyzer.

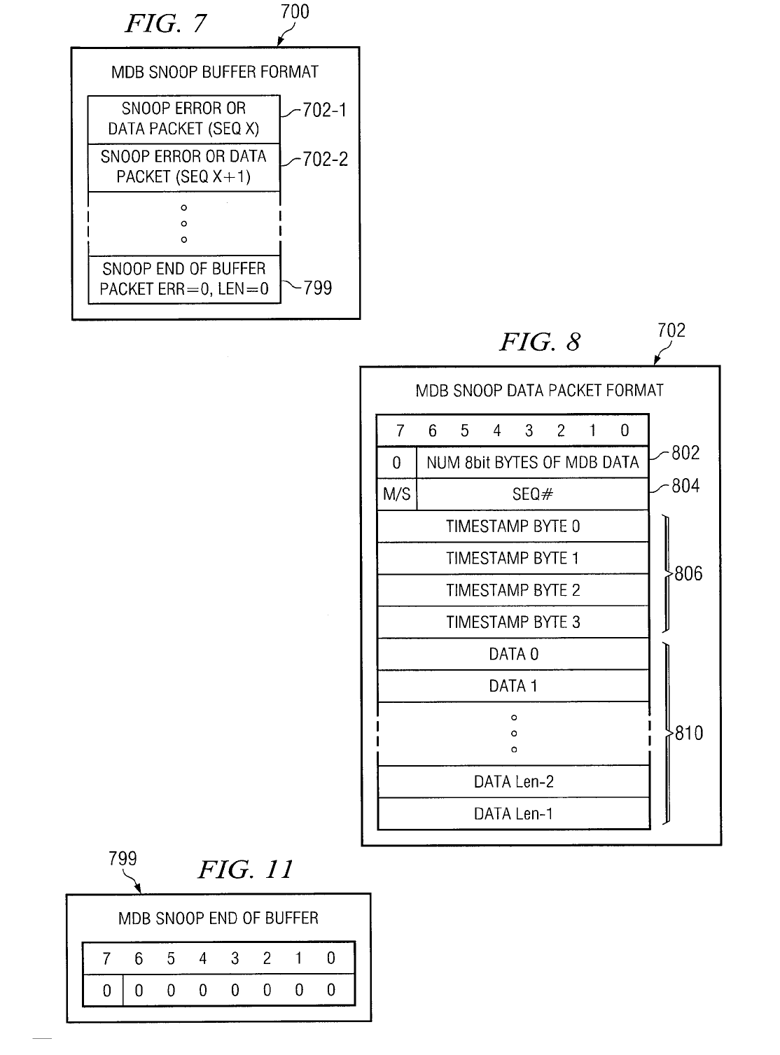

Snoop filter driver 630 is preferably configured for checksum validation and filtering raw blocks of MDB data assembled by MOE firmware 610. A suitable format for an MDB data buffer 700 is described with respect to FIG. 7 through FIG. 11. MDB data buffer 700 includes a series of MDB data packets 702 (and/or) MDB error packets 704 followed by an end-of-buffer (EOB) packet 799.

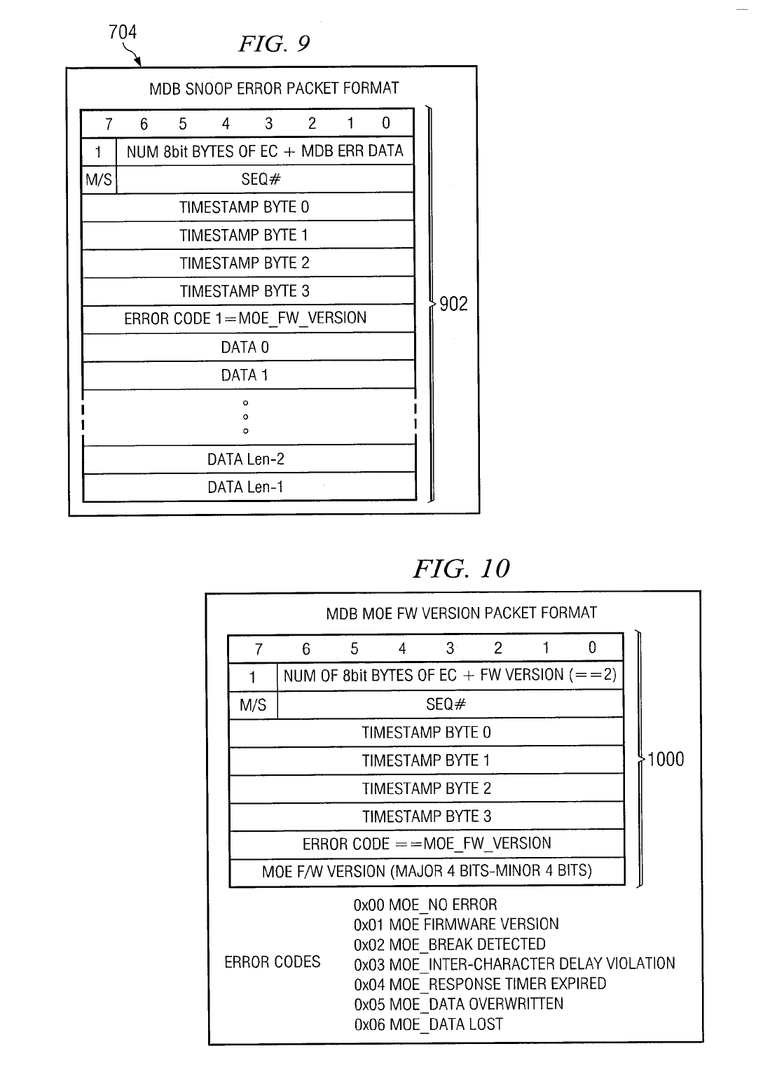

An MDB data packet 702 includes a 7-bit value 802 indicating the length of the packet, a 7-bit value 804 indicating the origin of the packet, a 4-byte time stamp 806, and a sequence of data bytes 810. An MDB error packet 704 is depicted in FIG. 9. Similar in format to data packet 702, error packet 704 includes line-level protocol error indications such as inter-character delay violations and line exclusivity violations. The error data packet is indicated by the presence of a “1” in the high order bit. Error packets 704 also include a byte 902, positioned immediately prior to data bytes, indicating the MOE firmware version. An MOE firmware version packet 1000 has its own format as depicted in FIG. 10. The EOB packet 799 is depicted as a “null” packet in FIG. 11.

Returning to FIG. 6, snoop filter driver 630 is implemented as a low priority user mode thread that filters data packets under control of Snoop Application 640. MOE device driver 620 provides control signals to MOE firmware 610 under control of MOE application 640 and receives interrupts and raw data from MOE firmware 610. MOE device driver 620 is responsible for managing a communication layer of the platform and will provide the XScale-side “glue” necessary to retrieve MDB block data from the MOE 430. This glue includes code to service hardware interrupts, program the DMA controller, and allocate DMA capable buffers in system memory. A pool of DMA capable buffers is preferably pre-allocated at driver load time and is preferably reused as needed to prevent repeated dynamic allocations and thereby prevent fragmentation and eliminate the possibility of resource induced delays and possible packet loss.

Although the present invention has been described with respect to a specific preferred embodiment thereof, various changes and modifications may be suggested to one skilled in the art and it is intended that the present invention encompass such changes and modifications fall within the scope of the appended claims.

What is claimed is:

1. A field asset suitable for use in a machine to machine environment, comprising:
a machine controller configured to function as a master of a shared bus;
one or more slave peripheral devices connected to the bus, wherein the machine controller transmits packets to the peripheral devices via the shared bus; and
a snoop agent configured to capture packets transmitted on the shared bus.

2. The field asset of claim 1, wherein the machine controller is the sole master of the shared bus and further wherein the slave peripheral devices transmit packets only in response to receiving packets from the machine controller.

3. The field asset of claim 1, wherein the peripheral devices include a coin mechanism, a bill validator, and a card reader.

4. The field asset of claim 3, wherein the card reader is coupled to an extended function adapter (EFA), wherein the extended function adapter also provides the snoop agent.

5. The field asset of claim 1, wherein the snoop agent is implemented on an extended function adapter (EFA) connected to an MDB.

6. The field asset of claim 5, wherein the EFA includes an embedded controller, a UART coupled to the MDB, access to storage or memory, and peripheral component interfaces.

7. The field asset of claim 6, wherein the snoop agent includes a microcontroller coupled to the embedded processor.

8. The field asset of claim 1, wherein the shared bus is a Multi Drop Bus (MDB) protocol compliant bus and wherein the machine controller is a vending machine controller (VMC) connected to the MDB via an MDB port of the VMC.

9. The field asset of claim 8, further comprising an audit agent connected to a DEX port of the VMC and suitable for retrieving DEX data from said DEX port.

10. The field asset of claim 9, wherein the audit agent and the snoop agent are both provided on an extended function adapter (EFA) connected to the MDB.

11. An extended function adapter (EFA) suitable for use in a field asset of a machine to machine environment, wherein the EFA is operable to connect to a shared bus of the field asset and wherein the EFA includes an MDB offload engine enabled to capture data packets on the shared bus.

12. The adapter of claim 11, wherein the shared bus is a multi-drop bus protocol (MDB) compliant bus.

13. The adapter 12, further comprising an audit agent suitable for retrieving Data Exchange (DEX) formatted data from a vending machine controller connected to the MDB compliant bus.

14. The adapter of claim 11, wherein the EFA comprises an embedded processor and wherein the MDB offload engine comprises a microcontroller in communication with the embedded processor.

15. The adapter of claim 14, wherein the MDB offload engine buffers captured packets and interrupts the embedded processor when a buffer is full or otherwise ready.

16. The adapter of claim 14, wherein a Master TX line and a Master RX line of the shared bus are routed to first UART associated with the embedded processor and to a second UART associated with the microcontroller.

17. The adapter of claim 16, wherein the microcontroller transfers captured data to memory coupled to the embedded processor via direct memory access using an SSP port.

18. A computer program product comprising processor executable instructions, stored on a computer readable medium, for capturing packets on a shared bus of a field asset in a machine to machine environment, the program product including:
instructions for enabling a microcontroller to capture packets transmitted over the shared bus;
instructions for enabling the microcontroller to send captured packets to an embedded processor for analysis.

19. The computer program product of claim 18, further comprising instructions for enabling the microcontroller to filter shared bus traffic to capture packets selectively.

20. The computer program product of claim 18, wherein the shared bus is an MDB compliant protocol bus.
